(19) United States
(12) Patent Application Publication
(10) Pub. No.: US 2008/0226526 A1
(43) Pub. Date: Sep. 18, 2008

(54) Carbon Dioxide Acceptors

(75) Inventors: Magnus Ronning, Trondheim (NO); Esther Ochoa-Fernandez, Trondheim (NO); Tor Grande, Trondheim (NO); De Chen, Trondheim (NO)

Correspondence Address: KNOBBE MARTENS OLSON & BEAR LLP, 2040 MAIN STREET, FOURTEENTH FLOOR, IRVINE, CA, 92614, US

(73) Assignee: NTNU TECHNOLOGY TRANSFER AS, Trondheim (NO)

(21) Appl. No.: 11/911,804

(22) PCT Filed: Apr. 18, 2006
(86) PCT No.: PCT/EP06/03507

§ 371 Date: May 13, 2008

(30) Foreign Application Priority Data
Apr. 18, 2005 (NO) 20051886
Nov. 29, 2005 (GB) 0524291.2

(51) Int. Cl. B01D 53/62; C01D 1/02; C01F 11/02; C01F 5/00; C01F 3/02; C01F 7/02; C01B 33/20; C01G 25/02

(52) U.S. Cl. 423/230; 423/593.1; 423/594.15; 423/594.16; 423/600; 423/326; 423/594.12

(57) ABSTRACT

A process for the preparation of a nanoparticulate carbon dioxide acceptor. The acceptor is a mixed metal oxide having at least two metal ions X and Y. The process includes contacting in solution a precursor of an oxide of metal ion X and a precursor of an oxide of metal ion Y; drying said solution to form an amorphous solid; and calcining the amorphous solid to form the acceptor.

This invention relates to a process for the preparation of nanoparticulate carbon dioxide acceptors, to acceptors made by the process, to the use thereof in a variety of processes to capture CO₂, to structures such as membranes formed from the nanoparticulate materials and to the regeneration of the acceptors.

Global warming is, perhaps, the largest challenge facing the human race today. Presently, about 29 billion tons of CO₂ are released into the air annually by human activities such as the burning of fossil fuels. As countries such as China and India become more industrialised, this figure is expected to rise.

In view of the catastrophic effects on climate caused by carbon dioxide, the majority of countries have signed up to the Kyoto protocol which aims to reduce these emissions and it is now well known to try to remove CO₂ from exhaust gases in industrial plants to minimise emissions in the air.

Scientists have devised a variety of ways of removing CO₂ from exhaust gases. Currently available technologies include physical and chemical absorption or adsorption, cryogenic processes and gas separation membranes.

Removal of CO₂ from exhaust gases is a feature of certain industrial processes, e.g. for the production of hydrogen and power generation. Sorption enhanced steam reforming (SESMR) is a particular process for producing hydrogen where relatively pure hydrogen can be produced at much lower temperatures then in conventional procedures.

There has been extensive research carried out on carbon dioxide capture at atmospheric pressure and ambient temperature. Much less research has been carried out, however, into the capture of carbon dioxide at higher temperatures and pressures. It would be preferable if carbon dioxide removal could be achieved under these conditions since typical exhaust gases from power plants and the like are hot. Moreover, SESMR takes place at high temperatures and an acceptor of use in this process also needs to work effectively under high temperature conditions.

In J Electrochem. Soc. 145, (1998) 1344, Nakayawa reports that Li containing materials (mainly Li₂ZrO₃ and Li₄SiO₄) are promising candidates with high carbon dioxide capture capacity and high stability. Nakagawa et al. have reported that lithium zirconate can theoretically hold carbon dioxide in amounts up to 28 wt % acceptor weight at high temperatures according to the following reaction:

Li₂ZrO₃+CO₂ [symbol] Li₂CO₃+ZrO₂

The high capture capacity and stability at a temperature range of 450-600° C. make it promising for application in, for example, SESMR. However, kinetic limitations are a serious obstacle to the use of Nakagawa's material. It takes a very large amount of time for carbon dioxide to be captured by the compounds described making them unsuitable for use industrially where rapid capture of carbon dioxide and rapid regeneration of the acceptor material are essential for a successful acceptor. The present inventors therefore sought material which is capable of accepting carbon dioxide rapidly.

The synthesis of lithium containing ceramic powders has been extensively studied, especially the synthesis of lithium zirconate. Various solid state processes have been employed to fabricate the lithium zirconate powders. Solid state reactions between ZrO₂ and lithium peroxide (or carbonate) are the best known processes and are used by Nakagawa to make Li₂ZrO₃. In these processes, two types of powders are mechanically mixed, and treated at high temperatures. Solid state reactions normally require high temperatures and long reaction time. In addition, the final particle size is normally large, partially due to sintering during the high temperature treatment.

There have been several efforts to reduce the starting powder size for solid state processes. One example is the use of a sol-gel technique to prepare fine powders of ZrO₂. However, this powder is subsequently reacted in solid state with lithium carbonate at high temperatures with consequential sintering problems. A precipitation combustion process has also been reported to synthesise Li₂ZrO₃ powder as breeding material for fusion reactors.

The present inventors have surprisingly found that nanoparticulate lithium zirconate and other mixed metal oxides can be prepared by a solution based chemistry preparation method instead of the traditional solid state reaction. This has very significant effects on the kinetic properties and stability of the formed mixed metal oxide. Thus, the new materials have been found to capture carbon dioxide much more rapidly than those of the prior art. Complete saturation of the acceptor can, in some circumstances, be achieved in 3 minutes.

Thus, viewed from one aspect the invention provides a process for the preparation of a nanoparticulate carbon dioxide acceptor, said acceptor being a mixed metal oxide comprising at least two metal ions X and Y, wherein said process comprises contacting in solution a precursor of an oxide of metal ion X and a precursor of an oxide of metal ion Y;

drying said solution to form an amorphous solid; and

calcining said amorphous solid to form said acceptor.

Viewed from another aspect, the invention provides a nanoparticulate acceptor prepared by the process as hereinbefore defined.

By nanoparticulate means that the particles of acceptor formed by the process of the invention are nanoparticles, i.e. less than 500 nm, preferably less than 300 nm, especially less than 100 nm in diameter. Most preferably, the particles are around 2 to 80 nm in diameter, e.g. 10 to 50 nm, especially 10 to 25 nm in diameter. Particles diameters can be measured using well known techniques such as electron microscopy. The nanoparticles are preferably crystalline.

It is believed that the use of nanoparticulate acceptors improves the kinetic ability of the acceptor to capture carbon dioxide and improves the ease of regeneration of the acceptor.

The nanoparticles may coagulate to form larger porous particles normally with relatively uniform size between 1-2 μm. These particles display a characteristic geometry; large spheres with holes resembling a doughnut-like shape were found. Without wishing to be limited by theory, it is envisaged that when the dried complex powder is heated to a certain temperature, the oxidation of any organic compounds present leads to a smouldering process involving gas evolution. This gas evolution results in loosely agglomerated particles with mesopores.

The acceptors of the invention are capable of capturing carbon dioxide. The acceptors are mixed metal oxides comprising at least two different metal ions X and Y. A first metal ion X is preferably selected from groups I or II of the periodic table, i.e. is an alkali metal or alkaline earth metal, or a transition metal in the 1⁺, 2⁺ or 3⁺ oxidation state. Preferably, the X ion is an alkali metal ion or alkaline earth metal ion.

Preferably, the metal ion X is an ion of Li, Na, Mg, K, Ca, Sr or Ba. Most preferably, the metal ion X is lithium, sodium or calcium, especially lithium.

The second metal ion Y is preferably from the transition metal or lanthanide series of metals or is an ion of Al, Si, Ga, Ge, In, Sn, Tl, Pb or Bi. Metal ions X and Y must be different. Preferably, Y is a transition metal ion, Al ion or a silicon ion. Preferred transition metal ions are in groups 3 to 6 of the periodic table especially group 4. Most preferably the metal ion is of titanium or especially zirconium.

The metal ions X and Y can be in any convenient oxidation state. For metal ions X this will typically be 1⁺ or 2⁺. For metal ion Y, preferred oxidation states include 3⁺ and 4⁺.

The acceptors of the invention are formed by first contacting in solution a precursor of an oxide of metal ion X and a precursor of an oxide of metal ion Y. This can be readily achieved by mixing a solution of a precursor material containing a metal ion X with a solution of a precursor material containing a metal ion Y. By solution is meant that the precursor material is dissolved. Any suitable solvent could be employed but the solutions are preferably aqueous. Deionised water is preferably employed.

It would, of course, be possible to effect contact between the ions by adding a soluble precursor material in solid form to a solution of the other precursor material. This is not preferred however, as it is a preferred feature of the invention if the amounts of precursor are mixed in an exactly stoichiometric fashion. Thus, if the target mixed metal oxide has two moles of metal ion X to one mole of metal ion Y, exactly two moles of X to one mol of Y should be employed. This is most easily achieved if solutions are preprepared separately and gravimetrically assessed. The person skilled in the art will be able to devise all manner of ways of contacting the necessary precursor materials.

By precursor to an oxide is meant that the precursor material is convertible to its oxide upon the application of heat. Each precursor material must therefore be capable of being converted to its corresponding oxide under heat. It may be the case that the oxide of the metal is unstable. In this scenario, the oxide which is formed may further convert into, for example, its carbonate upon heat application via its oxide.

Suitable precursor materials of either metal ion X or Y therefore include for instance nitrates, nitrites, carboxylates (e.g. acetates), halides (e.g. chlorides), sulphates, sulphides or salts of acids comprising multicarboxyl groups (e.g. citrates). The precursor material may also be an oxide containing precursor material in which another counter ion is also present, e.g. a metal oxide nitrate such as zirconyl nitrate. Suitable counter ions therefore include those listed above. Precursor materials may possess water of crystallisation.

The precursor material needs to be soluble so nitrates, carboxylates/salts of acids and oxides with other counter ions are especially preferred. For the formation of lithium zirconate, preferred precursor materials are lithium acetate and zirconyl nitrate. It is also preferred if at least one of the precursor materials contains an organic counter ion. Organic counter ions oxidise during the calcination process releasing gas which aids the formation of porous agglomerated particles as described above. It is also preferred to use an organic counter ion where the oxide which will be formed upon the application of heat is unstable. The presence of the organic counter ion provides a carbon source allowing decay of the oxide into a carbonate. The person skilled in the art will be able to devise a variety of suitable soluble precursor materials.

Contact between the metal ions can be effected under ambient conditions of temperature and pressure. The solution can be mixed to ensure ideal contact between the ions and the solution can be left for a prolonged period (e.g. at least 2 hours).

After the two precursor materials have been contacted with each other, and if necessary mixed and left, the solution is dried e.g. by lyophilisation, by spray drying or on a hot plate. Spray drying is especially preferred. The resulting material is an amorphous solid, typically a powder, with good flowability. It is not necessary therefore to carry out any other specific dehydration step, e.g. using azeotropes. The drying step should preferably follow the step of precursor contact directly. Preferably, drying is the only dehydration step employed.

The solid obtained can then be calcined to form the nanoparticulate acceptor material. Calcination involves heating the material at a temperature of from 300 to 1000° C., preferably 400 to 800° C., more preferably 500 to 700° C., especially 550 to 600° C. Any organic counter ions may be ignited at temperatures lower than 500° C. It is a particular feature of this invention that calcination can be effected at lower temperature than reported in the literature.

This second metal ion component Y typically forms an oxy anion in the acceptor, e.g. an Y_{y}O_{z}^{q-} where y is between 1 and 2, z is between 3 and 7 and q is between 1 and 6. The subscripts y and z may be integers but are not necessarily integers, i.e. non-stoichiometric compounds may be formed. The metal ion X is then used to satisfy the valency of this ion thus forming the overall oxide acceptor.

Thus, the acceptor is a mixed metal oxide and can be any convenient oxide depending on the nature of the metals. Thus, the acceptor may be of formula XYO₂, XYO₃, XYO₄, XY₂O₄, X₂YO₄ etc. Preferably, the oxide is of formula X₂YO₃.

Ideally, the acceptor will possess a tetragonal crystal structure. Most preferably, the acceptor is lithium zirconate (Li₂ZrO₃).

The acceptors may contain just two metal ions but they may also be doped with minor (e.g. less than 10 mol %, such as 0.1 mol % to 5 mol %) of one or more other metal ions. Suitable doping metal ions include those from groups (I) and (II) as well as transition metal ions. Especially preferred doping metal ions are Na⁺ and K⁺. It will be appreciated that the doping metal ion(s) needs to be different from the metal ions used to form the main body of the acceptor.

Doping of the nanoparticulate materials can be achieved by different methods: impregnation, precipitation or preferably by adding into the precursor solution, an ion of the metal or metals with which it is desired to dope the material. The amount of precursor material added governs the amount of doping that will be present in the formed acceptor. The doping metal can be added as part of a soluble precursor material as described above for ions X and Y, i.e. the precursors will typically be in a form which is convertible to an oxide or, if this is unstable, its carbonate under heat. A suitable doping metal ion precursor may therefore be a nitrate. Thus, potassium doping could be achieved by adding potassium nitrate to a precursor solution.

Doping can occur on either the X or Y sites in the acceptor. Where doping occurs on the X site the dopant metal ion is preferably a group (I) or (II) metal. Where doping occurs on the Y site, the dopant metal ion is preferably a transition metal, ideally of the same valence as the Y cation present. Preferably, doping occurs on the X site. In this scenario, it will be appreciated that the amount of ion X and dopant present need to add up to satisfy the valency of the oxy anion. Thus, acceptors of the invention may have a structure XₐD_{b}YO₂, XₐD_{b}YO₃, XₐD_{b}YO₄, XₐD_{b}Y₂O₄, XₐD_{b}YO₄ where D is a doping metal ion and subscripts a and b total the valency of the oxy anion. Here, b may be around 0.001 to 0.2 in value. The subscript “a” will typically be 1-b or 2-b. Preferably, a doped acceptor will be of formula X_{2-b}D_{b}YO₃. In this case b is preferably 0.001 to 0.2 in value, e.g. 0.01 to 0.1. This formula could be adapted for multiple dopants (e.g. X_{2-b-f}D_{b}E_{f}YO₃ where E is a further doping metal ion and f has the values described for b).

Where the Y site is doped, a suitable acceptor might be X₂Y_{1-c}D_{c}O₃ where c is 0.001 to 0.1 in value, e.g. 0.01 to 0.05. This formula could also be adapted for multiple dopants and the other formula shown above could be adapted in a similar fashion.

It is also be possible to dope on both X and Y sites.

A preferred nanoparticulate acceptor material is formed from lithium zirconate. Lithium zirconate can theoretically accept CO₂ in amounts up to 28% acceptor weight at high temperatures according to the following reaction:

Li₂ZrO₃+CO₂ [symbol] Li₂CO₃+ZrO₂ Equation 1

Capture preferably takes place between 400 and 700° C. The theoretical limit can be achieved only if the acceptors are utilised at the lower end of this temperature range and at high carbon dioxide partial pressure but such conditions are seldom convenient industrially. The inventors have found however, that the nanoparticulate acceptors of the invention are able to take more than 20 wt % CO₂ at temperatures of the order of 550° C., a useful industrial temperature.

The acceptors are therefore preferably employed at temperatures in the range of 500 to 700° C., more preferably in the range 550-650° C., preferably 575° C.

Moreover, it has also been found that the acceptors of the invention are able to accept carbon dioxide very rapidly. Thus, in an embodiment of the invention, the acceptors of the invention are able to capture at least 8 wt %, preferably at least 10 wt %, more preferably at least 12 wt %, especially at least 15 wt % of their own weight of carbon dioxide, highly preferably at least 20 wt % of their own weight of carbon dioxide. This can be achieved in a period of less than 1 hour, preferably less than 30 mins, especially less than 10 mins, most especially less than 5 mins.

As mentioned above, the partial pressure of carbon dioxide affects the capture properties of the materials claimed. Higher partial pressures are associated with improved carbon dioxide capture rates.

The presence of water improves both the capture and the regeneration rates. Thus, any carbon dioxide capture process may preferably be run in the presence of steam.

As noted in equation 1 above, the reaction between the mixed metal oxide acceptor and carbon dioxide is reversible. Thus, the material can be reused if regeneration of the carbon dioxide is effected.

The nanoparticle CO₂ acceptor according to the invention releases reversibly substantially all its carbon dioxide at, for example, a temperature in the range of from 500-800° C., preferably from 550-650° C. Thus, a further beneficial feature of the nanoparticulate CO₂ acceptors of the invention is that they are readily regenerated. Moreover, the regeneration can be carried out at the same or a similar temperature to the carbon dioxide capture.

Regeneration of the acceptor can be carried out using an inert gas but is preferably carried out using high temperature steam. In such a process, the acceptor is exposed to steam at the temperatures above (e.g. 500 to 800° C.), especially 550 to 650° C. During the regeneration process carbon dioxide is released and can be stored. Thus, it is possible for the capture process to be stopped, the acceptor regenerated and capture to be restarted without having to remove the acceptor from its location or to significantly change the temperature of reaction. As regeneration can occur rapidly, (e.g. in the same time or faster than absorption e.g. less than 1 hour, preferably less than 30 mins, especially less than 15 mins) this allows for successive capture and regeneration steps to be carried out.

This forms a further important embodiment of the invention which therefore provides a process for capturing carbon dioxide from a gas stream containing carbon dioxide said process comprising:

(I) contacting a nanoparticulate acceptor material as hereinbefore described with a gas stream containing carbon dioxide;
(II) once a predetermined amount of carbon dioxide has been captured (e.g. 15 wt % relative to the weight of the acceptor) stopping contact between the gas stream and acceptor;
(III) regenerating the acceptor by releasing the captured carbon dioxide (e.g. by subjecting the acceptor to high temperature steam); and optionally
(IV) repeating steps (I) to (III).

Thus, it is envisaged that an exhaust gas containing carbon dioxide could be passed into a fluidised bed reactor or multiple reactor system, e.g. two reactor system. The exhaust gas could be passed into a first reactor containing the acceptor. Once the acceptor had taken its full amount of carbon dioxide the acceptor can be regenerated, e.g. using steam and the released carbon dioxide captured and stored. Meantime, the exhaust gas can be transferred to a second reactor to continue the capture process. Once the second acceptor has taken its full amount of carbon dioxide, it too can be regenerated whilst the exhaust gas returns to the first reactor. Since capture and regeneration take similar amounts of time using the materials of the invention, the acceptor in the first reactor is now regenerated and ready to recapture carbon dioxide. It will be clear that the principles of this process can be expanded to any number of reactors.

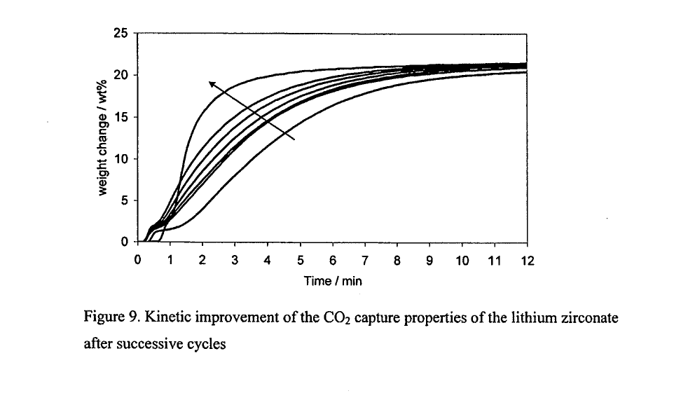

The inventors have moreover found that the stability of the acceptors of the invention is excellent. As shown in the examples, repeated capture and regeneration leads to no significant drop off in capture capabilities. Thus, the material is stable at the temperatures under which it is designed to operate. Furthermore, FIG. 9 suggests that the kinetics of the material actually improves. Thus, after a series of capture and regeneration steps, the material actually captures carbon dioxide more rapidly than it did at first instance.

The acceptors of the invention can be employed in carbon dioxide removal from any desired mixture and can be employed in any desired form. They can, for example, be mounted on a support material if necessary or formed into membranes. Suitable support materials include quartz, silica, ceramic materials or stainless steel.

Viewed from another aspect therefore the invention provides a membrane comprising a nanoparticulate acceptor as hereinbefore described.

The acceptors are of particular utility in removing carbon dioxide in the exhaust gases of power generation plants or any other industrial plant where large amounts of carbon dioxide might be released.

A conventional power station burning coal or oil gives off significant amounts of carbon dioxide in its exhaust gases. Approximately 0.3 to 0.5% carbon dioxide can be found in such gases. The acceptors of the invention can therefore be employed in removing carbon dioxide from the exhaust gases of conventional power plants, especially at high temperatures and pressures.

Thus, viewed from a further aspect, the invention provides a process for removing carbon dioxide from the exhaust gases of, for example, a power generation plant, wherein said exhaust gases are contacted with an acceptor as hereinbefore described.

Most preferably however, the materials can be applied in steam reforming, a major process for the production of hydrogen and energy in processes such as pre-combustion. In the reforming process methane is mixed with steam to form carbon monoxide and hydrogen. The carbon monoxide can then react with water to form carbon dioxide and more hydrogen. The overall chemical process is shown below.

Reforming: CH₄+H₂O [symbol] CO+H₂
WGS: CO+H₂O [symbol] CO₂+H₂
Overall CH₄+2H₂O [symbol] CO₂+4H₂
(WGS=water gas shift)

This reaction is quite endothermic and typically takes place at between 700 to 1000° C. at 20 to 30 bars pressure. The process is therefore highly energy demanding. The reaction is catalysed with a known nickel catalyst.

The reaction of carbon dioxide with the mixed metal oxides of the invention tends to be highly exothermic. Thus, if the reaction with lithium zirconate is considered the overall scheme for steam reforming is

CH₄+2H₂O+Li₂ZrO₃ [symbol] 4H₂+Li₂CO₃+ZrO₂

This has an overall enthalpy at 25° C. of 5 kJ/mol making the acceptors of the invention ideal for use in steam reforming. In fact, by using the acceptors of the invention successful reformation can be achieved at temperatures in the range 500 to 650° C., much lower than conventionally required. The use of lower temperatures means a cheaper process and less risk of coking.

Moreover, as is known, it is necessary for hydrogen to be very pure to allow its use in fuel cell technology. The acceptors of the invention allow separation of hydrogen from carbon dioxide in high purity, e.g. at least 95% purity in a single stage.

More importantly however, by using the acceptors of the invention, the equilibrium of this reaction can be dragged to the right. As the acceptor removes carbon dioxide from the product gas stream it inevitably pulls the equilibrium over to the right hand side thereby increasing the amounts of hydrogen formed. This is termed sorption enhanced steam methane reforming.

This forms a highly preferred embodiment of the invention. Thus, viewed from a further aspect, the invention provides a process for sorption enhance steam methane reforming comprising capturing carbon dioxide from the exhaust gas of the reforming process using an acceptor as hereinbefore described.

In any process in which the acceptor of the invention are used, it will of course be possible to use multiple layers of acceptor to maximise removal.

The carbon dioxide which is removed by the acceptors is released during the regeneration process. The carbon dioxide can then be stored, e.g. in compressed gas containers. The carbon dioxide can be utilised if necessary in any applicable industrial process but the market for carbon dioxide is quite small. More commonly therefore, the carbon dioxide can simply be stored rather than released into the atmosphere thus fuelling global warming.

The invention will now be described with reference to the following non-limiting examples and figures.

Description of the figures:

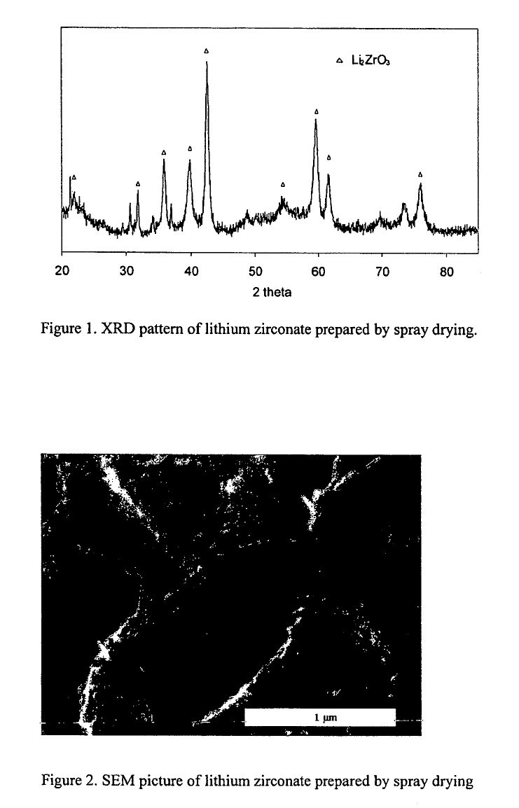

FIG. 1. XRD pattern of lithium zirconate prepared by spray drying and calcined at 600° C. for 6 hours.

FIG. 2. SEM picture of lithium zirconate prepared by spray drying and calcined at 600° C. for 6 hours.

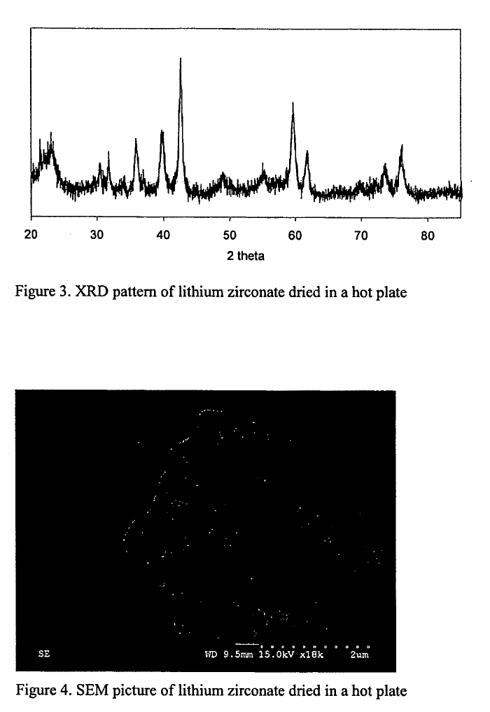

FIG. 3. XRD pattern of lithium zirconate dried on a hot plate and calcined at 600° C. for 6 hours.

FIG. 4. SEM picture of lithium zirconate dried in hot plate and calcined at 600° C. for 6 hours.

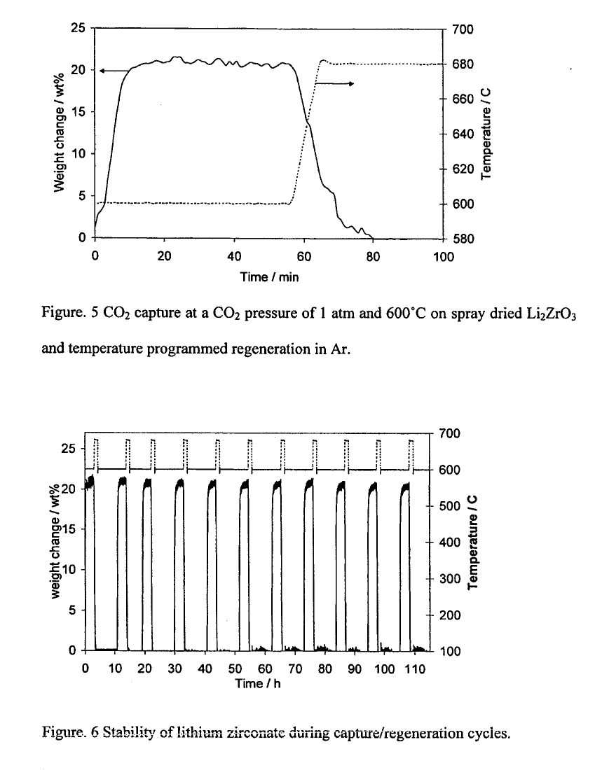

FIG. 5. CO₂ sorption uptake and regeneration curve of lithium zirconate prepared by spray drying.

FIG. 6. Stability of the lithium zirconate prepared by spray drying.

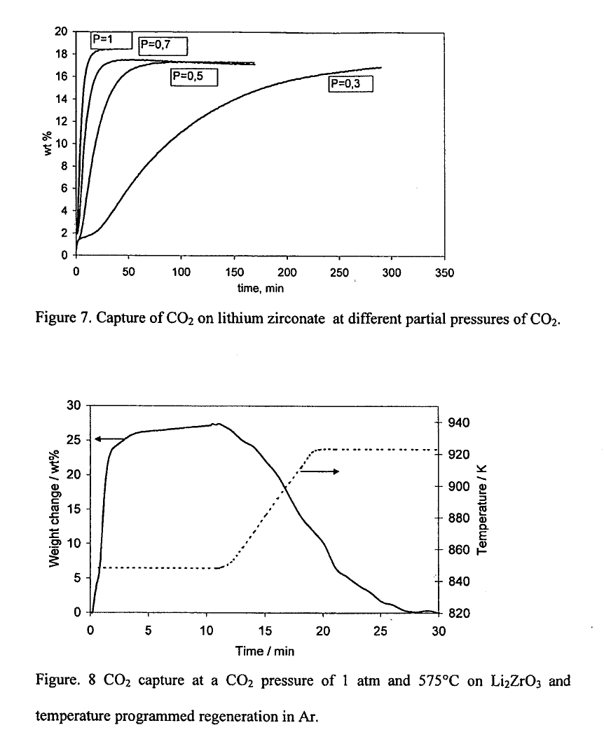

FIG. 7. Capture of CO₂ on lithium zirconate at different partial pressures of CO₂

FIG. 8. CO₂ capture of lithium zirconate dried in a hot plate.

FIG. 9. Kinetic improvement of the CO₂ capture properties of the lithium zirconate after successive cycles

### EXAMPLES

### Example 1

SolA: 100 g of zirconyl nitrate hydrate was dissolved in 1 liter deionised water.

SolB: 100 g of lithium acetate dihydrate was dissolved in 1 litre deionised water. The mixtures were stirred overnight and stored in a hermetic bottle.

### Example 2

The solutions prepared in Example 1 were standardised by thermogravimetric analysis in order to calculate the amount of ZrO₂ and Li₂O per g of solution that can be obtained by their calcination. For this purpose, known amounts of each solution were placed in previously dried alumina crucibles. The samples were calcined and the weight of the resulting oxides was measured. The alumina crucibles were dried and calcined in a muffle furnace for 12 h at 1000° C. The heating and cooling rates were 200° C./h. As a result it was obtained: 3.03×10⁻⁴ mol ZrO₂/g solA and 5.02×10⁻⁴ mol Li₂O/g solB.

### Example 3

Appropriate amounts of solA and solB prepared in Example 1 were mixed in order to synthesise 10 g of Li₂ZrO₃ (0.065 mol). According to standardisation results in Example 2: 215 g solA (0.065 mol ZrO₂) and 130 g solB (0.065 mol Li₂O) are mixed and stirred overnight.

### Example 4

The solution prepared in Example 3 was dried in a spray-drier (Mini Spray-Drier B-191, BÜCHI) with an input temperature of 150° C. and a pump rate of 2 ml/min. The powder obtained after this step is white with a very good flowability.

### Example 5

The material prepared in Example 4 was calcined by placing a weighed amount of the material in an oven and raising the temperature at 2° C./min until 600° C. The material was kept at that temperature for 6 hours. The XRD pattern of this material shows high purity tetragonal lithium zirconate with an average crystal size of 20 nm, see FIG. 1. The morphology of the Li₂ZrO₃ powders was observed using a Hitachi S-4300se field emission scanning electron microscope. The results indicate that the single lithium zirconate crystals stick together to form large porous particles with relatively uniform size between 1-2 μm. All these particles present with a very characteristic geometry; large spheres with big holes that resemble a doughnut-like shape were found, see FIG. 2. Surface area was calculated to 4.75 m²/g and the pore volume 1.61 cm³/g.

### Example 6

The solution prepared in Example 3 was dried on a hot plate with continuous stirring at an input temperature of 100° C. The powder prepared was grounded with a mortar. The powder obtained after this step is white with a very good flowability.

### Example 7

The material prepared in Example 6 was calcined by placing a weighed amount of the material in an oven and raising the temperature at 2° C./min until the temperature was 600° C. The material was kept at that temperature for 6 hours. The XRD pattern of this material shows pure tetragonal lithium zirconate with an average crystal size of 21 nm, see FIG. 3. The morphology of Li₂ZrO₃ powders was observed using field emission scanning electron microscope. The results indicate that the single lithium zirconate crystals stick together to form large porous particles with size between 2-5 μm, see FIG. 4. Surface area was calculated to 3.66 m²/g and the pore volume 0.0076 cm³/g.

### Example 8

The CO₂ capture properties of the material prepared in Example 5 have been tested in a tapered element oscillating microbalance (TEOM). TEOM is based on changes in the natural frequency of an oscillating quartz element containing the sample in order to weigh the fixed acceptor bed. High mass resolution and short response time makes the TEOM particularly suitable for performing the uptake measurements. The tapered element was loaded with 20 mg of Li₂ZrO₃ together with quartz particles. Quartz wool was used on the top and bottom of the bed to keep the acceptor particles firmly packed. Samples were heated to 600° C. with a heating rate of 10° C. min⁻¹ in pure Argon gas and kept for 60 min. The CO₂ capture was started by switching Ar to 100% CO₂ at the same temperature. After saturation of the acceptor, temperature was increased to 680° C. and gas flow was changed from CO₂ to Ar to proceed with the regeneration reaction. Lithium zirconate prepared as in Example 5 can take CO₂ in an amount equivalent to 22 wt. % sample weight and complete saturation is reached within less than 10 min. Full regeneration takes place in 15-20 min at 680° C., see FIG. 5.

### Example 9

The material prepared in Example 5 was also tested at different temperatures in the range 550-600° C. following the same procedure as described in Example 8. The CO₂ capacity was around 20-22 wt. % for all the tested temperatures. The CO₂ uptake kinetics were dependent on the temperature with a maximum capture rate at 575° C.

### Example 10

The CO₂ uptake cycle stability of the material prepared in Example 5 was also tested following the same procedure described in Example 8. After more than 10 cycles. and more than 100 hours on stream, the acceptor displayed the same capacity (decrease <1 wt. %) and capture/regeneration kinetic properties, see FIG. 6.

### Example 11

The material prepared in Example 5 was also tested at different partial pressures of CO₂ (PCO₂=1, 0.7, 0.5, 0.3) at 550° C. following the same procedure described in Example 8. The CO₂ sorption capacity was 22 wt. % for all the tested partial pressures. Saturation is reached within 15 min at PCO₂=1. However, the capture rate gets slower when the PCO₂ is decreased. Full absorption was reached in 30, 45 and 100 min when PCO₂ was 0.7, 0.5 and 0.3, respectively, see FIG. 7.

### Example 12

The properties of the material prepared in Example 7 were tested at 575° C. following the procedure described in Example 8. The CO₂ capacity was around 20-22 wt. % and saturation was reached within 12 min. The capacity and capture rate of the material was considerably improved by modification on the stoichiometry. The CO₂ capacity was increased to around 26 wt. % and regeneration was reached within 3 min, see FIG. 8.

### Example 13

Appropriate amounts of solA and solB prepared in Example 1 are mixed in order to synthesise 2 g of Li₂ZrO₃ (0.013 mol). KNO₃ is added in order to prepare K doped lithium zirconate. The mixture is stirred overnight.

### Example 14

The solution prepared in Example 13 was dried on a hot plate with continuous stirring with an input temperature of 100° C. The as prepared powder was ground with a mortar. The powder obtained after this has a very good flowability.

### Example 15

The material prepared in Example 14 was calcined by placing a weighed amount of the material in an oven and raising the temperature at 2° C./min until the temperature was 600° C. The material was kept at that temperature for 6 hours.

### Example 16

The uptake properties of the material prepared in Example 15 were tested at 575° C. following the procedure described in Example 8. The CO₂ capture capacity was around 10-12 wt. % and saturation was reached within 1 min. The regeneration was carried out at the same temperature (575° C.) by switching to a pure Ar atmosphere. 80% of the CO₂ was desorbed within 5 min and the rest in the next 40 min.

### Example 17

The CO₂ sorption cycle stability of the material prepared in Example 5 was also tested following the same procedure described in Example 8. The kinetic properties after more than 10 cycles were not only stable, but improved, see FIG. 9.

1. A process for the preparation of a nanoparticulate carbon dioxide acceptor, said acceptor being a mixed metal oxide comprising at least two metal ions X and Y, wherein said process comprises
contacting in solution a precursor of an oxide of metal ion X and a precursor of an oxide of metal ion Y;
drying said solution to form an amorphous solid; and
calcining said amorphous solid to form said acceptor.

2. The process as claimed in claim 1 wherein the particles of the acceptor are less than 500 nm in diameter.

3. The process as claimed in claim 1 wherein the nanoparticles agglomerate to form larger porous particles of 1 to 2 μm in diameter.

4. The process as claimed in claim 1 wherein X is a group (I) or group (II) metal ion.

5. The process as claimed in claim 1 wherein X is Li⁺ or Na⁺.

6. The process as claimed in claim 1 wherein Y is a transition metal, Al or Si ion.

7. The process as claimed in claim 1 wherein Y is Zr⁴⁺.

8. The process as claimed in claim 1 wherein the precursor compounds are nitrates, carboxylates, salts of acids comprising multiple carboxyl groups or oxides comprising other counterions.

9. The process as claimed in claim 1 wherein the precursor of an oxide of metal ion X is an acetate.

10. The process as claimed in claim 1 wherein the precursor of an oxide of metal ion Y is zirconyl nitrate.

11. The process as claimed in claim 1 wherein drying is effected by spray drying.

12. The process as claimed in claim 1 wherein calcination is affected at a temperature of between 500 to 700° C.

13. The process as claimed in claim 1 wherein the acceptor is of formula XYO₂, XYO₃, XYO₄, XY₂O₄, or X₂YO₄.

14. The process as claimed in claim 1 wherein the acceptor is lithium zirconate.

15. The process as claimed in claim 1 wherein the acceptor is doped.

16. The process as claimed in claim 15 wherein the doping metal ion is potassium.

17. A nanoparticulate acceptor prepared by the process as claimed in claim 1.

18. The nanoparticulate acceptor as claimed in claim 17 wherein the particles of the acceptor have diameters in the range of 2 to 80 mm.

19. A process for the absorption of carbon dioxide comprising contacting carbon dioxide with a nanoparticulate acceptor as described in claim 17.

20. A process for capturing carbon dioxide from a gas stream containing carbon dioxide said process comprising:
(I) contacting a nanoparticulate acceptor material as claimed in claim 17 with a gas stream containing carbon dioxide;
(II) once an amount of carbon dioxide has been captured, stopping contact between the gas stream and acceptor;
(III) regenerating the acceptor by releasing the captured carbon dioxide, and optionally
(IV) repeating steps (I) to (III).

21. The process as claimed in claim 20 wherein the amount of carbon dioxide captured is at least 15 wt % of the weight of the acceptor.

22. The process as claimed in claim 20 wherein regeneration is effected using steam.

23. The process as claimed in claim 19 wherein capture and regeneration is effected at a temperature in the range 500 to 800° C.

24. A process for removing carbon dioxide from the exhaust gases of a power generation plant wherein said exhaust gases are contacted with an acceptor as claimed in claim 17.

25. A process for sorption enhance steam methane reforming comprising capturing carbon dioxide from the exhaust gas of the reforming process using an acceptor as claimed in claim 17.

26. (canceled)
